(19) United States
(12) Patent Application Publication
(10) Pub. No.: US 2004/0091280 A1
(43) Pub. Date: May 13, 2004

(54) IMAGE FORMING APPARATUS HAVING CHANGE-OVER TYPE DEVELOPING DEVICE

(75) Inventor: Toru Ono, Ibaraki (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/697,127

(22) Filed: Oct. 31, 2003

Related U.S. Application Data
(63) Continuation of application No. 10/286,815, filed on Nov. 4, 2002, now Pat. No. 6,701,110.

(30) Foreign Application Priority Data
Nov. 14, 2001 (JP) 348834/2001
Sep. 18, 2002 (JP) 271680/2002

(51) Int. Cl. G03G 15/00

(52) U.S. Cl. 399/82

(57) ABSTRACT

In an image forming apparatus including a latent image bearing member and a developing portion having a plurality of developing devices provided facing the latent image bearing member, since an inputting portion for inputting an image signal, an auto-discriminating portion for automatically discriminating the kind of an inputted image, and a control portion for changing over a first mode for executing monochrome image formation, a second mode for executing color image formation, and an auto-selecting mode for changing over the first mode and the second mode according to the discrimination of the auto-discriminating portion, capable of controlling such that movement of a predetermined developing device to a predetermined position is started before the auto-discriminating portion makes the discrimination in the case the auto-selecting mode is selected, are provided, at the time of starting the image formation by the auto-selecting mode, the developing device can be provided to the vicinity of the developing position so as to shorten the real average value of the FCOT by preliminarily rotating the developing device changeover portion to a standby position as the predetermined position so as to be rotated by the remaining angle to the developing position of the developing device after being turned out whether the image to be formed is monochrome or colored.

### BACKGROUND OF THE INVENTION

1. Field of the Invention

The present invention relates to an image forming apparatus comprising a latent image bearing member and developing means having a plurality of developing devices and provided opposite to the latent image bearing member at a predetermined developing position.

2. Related Background Art

Although conventional color image developing apparatuses include various different types, a developing step for color separation of an original image into three colors of yellow, magenta and cyan, or four colors additionally including black, and forming an electrostatic latent image for each color on a latent image bearing member (a photosensitive drum 202 shown in FIG. 1) so as to be developed with a toner by a developing device of the corresponding color is included commonly. According to the developing step, the developing device of each color executes the developing operation at a position adjacent to (or contacting with) the latent image bearing member. As the developing device arrangement configuration, a system with the developing devices of all the colors disposed adjacently to the latent image bearing member, and a system provided with a developing device change-over portion for bringing a developing device of the corresponding color into vicinity to (or into contact with) the latent image bearing member are involved.

Here, according to the system of changing over the developing devices, a slide mounting system, a rotary drum system (or, it is referred to also as a rotary color developing system), or the like are included, but many of them are put into practice by the rotary drum system. The rotary drum system is a system for development according to the rotating operation of a rotary color developing device 203 of FIG. 1 by rotation of a stepping motor (not shown) so as to bring a predetermined developing device of the developing devices 221 to 224 selectively according to each separated color to be developed around the rotation shaft 200 to a developing position adjacent to (or in contact with) the photosensitive drum 202. Therefore, compared with the configuration with the developing devices of respective colors disposed around the photosensitive drum as the latent image bearing member, it is advantageous in that a size reduction of the apparatus and a common architecture of the developing devices can be achieved. Particularly in the case of providing the developing devices themselves as the replaceable process cartridges in order to avoid troubles and labors accompanied by the toner supply, advantage by the common architecture of the developing devices is significant in terms of the cost.

However, according to the rotary drum system, the rotary color developing device 203 should be rotated at the time of changing over the developing devices, and thus it is disadvantageous in terms of the processing time in that the developing device change-over time is long compared with the slide mounting system. This disadvantage significantly influences, in particular, on the FCOT (First Copy Output Time) as the time for outputting the first sheet of paper from the start of the image forming step in the rotary drum system with all the four colors (yellow, magenta, cyan, black) mounted in the rotary color developing device for monochrome or color development.

For example, in the case of a rotary color developing device 203 with the developing devices of black, yellow, magenta, and cyan mounted in this order, a developing operation is executed by rotating operation of the rotary color developing device 203 according to rotation of a stepping motor so as to selectively bring a predetermined developing device in response to the color to be developed initially to a developing position adjacent to (or in contact with) the photosensitive drum 202 around the rotation shaft 200. That is, in the case of the monochrome development, it is black, and in the case it is color development, it is yellow. However, determination cannot be made to which of the black and yellow developing devices the rotary color developing device 203 should be switched until it is turned out whether the first original image is for a monochrome image or a color image. Therefore, the electrostatic latent image formation starting timing is a timing calculated from the developing device change-over completion scheduled time so that rotation of the rotary color developing device 203 is started after revealing whether the original image is for a monochrome image or a color image, and thus the time needed for changing over the developing device is delay time for the electrostatic latent image formation starting timing. This limitation has been the obstacle for shortening the FCOT.

### SUMMARY OF THE INVENTION

In consideration of the above-mentioned problems, the present invention has been achieved, and an object of the present invention is to provide an image forming apparatus comprising a latent image bearing member and a developing portion having a plurality of developing devices, wherein the real average value of the FCOT can be shortened according to control of starting movement of a predetermined developing device to a predetermined position before determination of the kind of the inputted image.

Specifically, in a color image forming apparatus using a rotary drum type developing device change-over system having a latent image bearing member and a plurality of developing devices, such as a color electrophotography copying machine and a color electrophotography printer, an effect of shortening the real average value of the FCOT by preliminarily rotating the rotary color developing device to a predetermined position at the time of receiving an image formation starting command can be provided.

Moreover, in an image forming apparatus comprising a latent image bearing member and a developing device having a plurality of developing devices and provided opposite to the latent image bearing member, since an inputting portion for inputting an image signal, an auto-discriminating portion for automatically discriminating the kind of an inputted image, and a control portion having a first mode for executing monochrome image formation, a second mode for executing color image formation, and an auto-selecting mode for changing over the first mode and the second mode according to the determination of the auto-discriminating portion, the control portion being capable of controlling such that movement of a predetermined developing device to a predetermined position is started before the auto-discriminating portion makes the determination in the case the auto-selecting mode is selected, are provided, at the time of starting the image formation in the auto-selecting mode, the developing device can be brought into the vicinity of the developing position so as to shorten the real average value of the FCOT by preliminarily rotating the developing device changeover portion to a standby position as the predetermined position so as to be rotated through the remaining angle to the developing position of the developing device after making a determination of whether the image to be formed is monochrome or colored.

Furthermore, in an image forming apparatus comprising a latent image bearing member and a developing device having a plurality of developing devices and provided opposite to the latent image bearing member, since an inputting portion for inputting an image signal, an auto-discriminating portion for automatically discriminating the kind of an inputted image, and a control portion having a first mode for executing image formation using a first developing device, a second mode for executing image formation without using the first developing device, and an auto-selecting mode for changing over the first mode and the second mode according to the determination of the auto-discriminating portion, the control portion being capable of controlling such that movement of a predetermined developing device to a predetermined position is started before the auto-discriminating portion makes the determination in the case the auto-selecting mode is selected, are provided, at the time of starting the image formation in the auto-selecting mode, the developing device can be brought into the vicinity of the developing position so as to shorten the real average value of the FCOT by preliminarily rotating the developing device change-over portion to a standby position as the predetermined position so as to be rotated through the remaining angle to the developing position of the developing device according to the kind of the image to be formed.

Moreover, since the standby position can be set by an operator or set automatically according to the frequency in use of the monochrome and the color in the image forming apparatus, the real average value of the FCOT can be shortened according to the use conditions.

Furthermore, in the image forming apparatus for using toners of different concentrations and components according to the mode, since it is controlled such that movement of a predetermined developing device to a predetermined position is started before making determination on the kind of the inputted image, the real average value of the FCOT can be shortened.

That is, for example, since the mode with a high frequency of use is set by the operator or set automatically between the monochrome mode and the color mode, and the standby position corresponding to the selected mode is selected with the priority, and the rotary color developing device is rotated preliminarily, the real average value of the FCOT can be shortened. Other objects and characteristics of the present invention will become apparent from the description and the drawings below.

### BRIEF DESCRIPTION OF THE DRAWINGS

FIG. 1 is a schematic cross-sectional view showing the entire schematic configuration of a color image forming apparatus according to an embodiment of the present invention.

FIG. 2 is a perspective view showing the essential part configuration of a light writing optical system.

FIG. 3 is a block diagram showing the essential part configuration of a control portion.

FIG. 4 is a diagram showing the relationship between a rotary color developing device and a control portion.

FIG. 5 is a diagram showing the configuration of an operating portion 303.

FIG. 6 is a diagram showing the standard screen of an LCD on an operating portion.

FIG. 7 is a diagram showing the essential part configuration of a digital image processing portion.

FIG. 8 is a block diagram showing the essential part configuration of a printer processing portion.

FIGS. 9A, 9B, 9C, 9D, 9E and 9F are diagrams showing the stopping positions of a rotary color developing device.

FIG. 10 is a chart showing the flow of the control.

### DETAILED DESCRIPTION OF THE PREFERRED EMBODIMENTS

Hereinafter, with reference to the accompanying drawings, a color image forming apparatus 50 of an embodiment of the present invention will be explained. In the drawings, the members designated by the same reference numerals represent the same members, and the redundant explanation will be omitted.

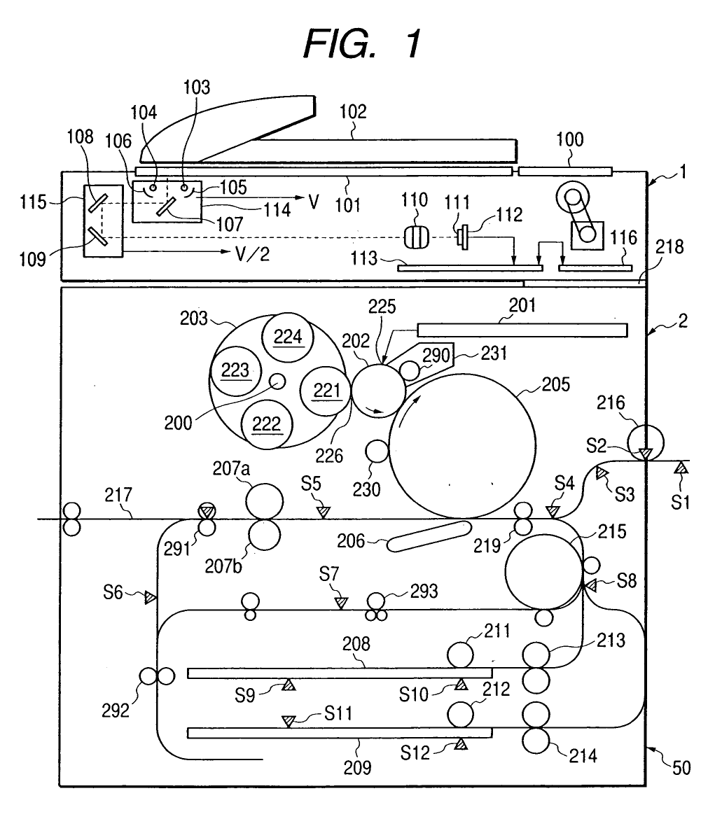

FIG. 1 is a schematic cross-sectional view of the color image forming apparatus 50. The color image forming apparatus 50 comprises a color image reader portion 1 (hereinafter referred to as the “reader portion 1”) in the upper part, and a color image printer portion 2 (hereinafter referred to as the “printer portion 2”) in the lower part.

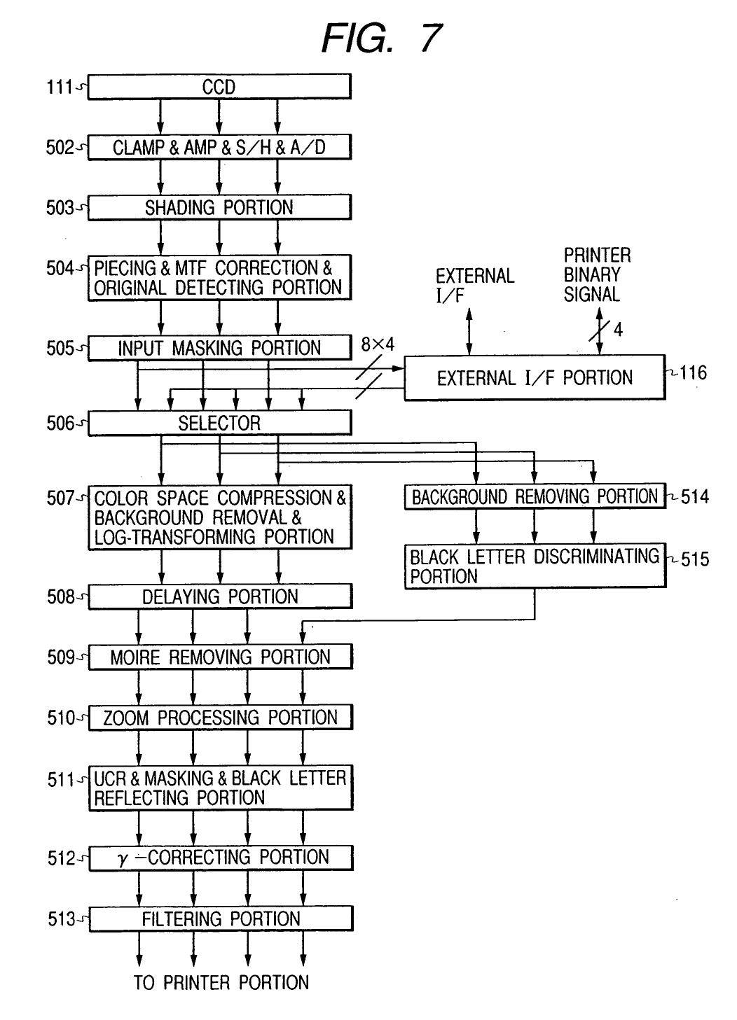

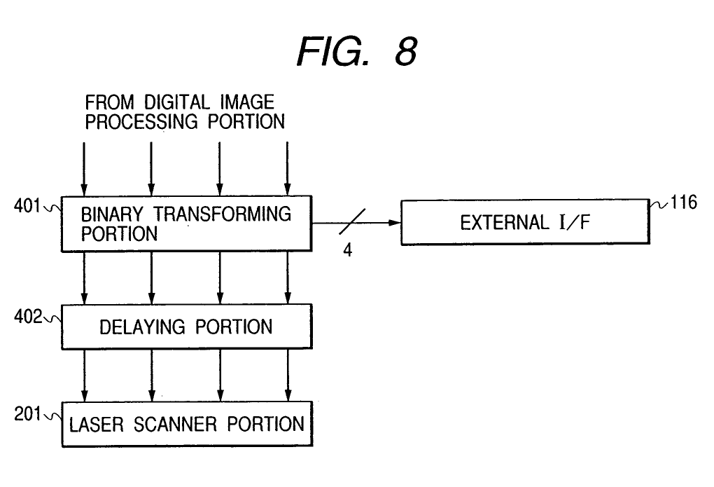

First, the configuration of the reader portion 1 will be explained. An original glass stand (platen) 101 and an auto original feeder (it is also referred to as the ADF) 102 are provided. A configuration with a mirror surface pressure plate or a white pressure plate (not shown) mounted instead of the ADF 102 can also be employed. As light sources 103, 104 for illuminating the original, a light source, such as a halogen lamp, a fluorescent lamp, a xenon lamp can be used. Troffers 105, 106 for condensing a light beam from the light sources 103, 104 onto the original, mirrors 107, 108, 109, and a lens 110 for condensing a reflected light beam or a projected light beam from the original onto a CCD (charge coupled device) image sensor (hereinafter referred to as the CCD) 111, are provided. A substrate 112 with the CCD 111 mounted, a control portion 100 for controlling the entire image forming apparatus, and a digital image processing portion 113 include the portion excluding the CCD 111 in FIG. 7 and the portions designated by the numerals 401, 402 in FIG. 8. A carriage 114 holds the light sources 103, 104, the troffers 105, 106, and the mirror 107. A carriage 115 holds the mirrors 108, 109. The carriage 114 is moved at a speed V, and the carriage 115 is moved at a speed V/2 mechanically in the sub scanning direction Y orthogonal to the electrically scanning direction (a main scanning direction X) of the CCD 111 so as to scan the entire surface of the original. An external interface (I/F) interfacing with the other devices 116 is connected electrically with the digital image processing portion 113.

Next, the configuration of the printer portion 2 will be explained. A printer control I/F 218 receives a control signal from a CPU 301 of the control portion 100 described later, so that the printer portion 2 operates based on the control signal from the printer control I/F 218. A photosensitive drum 202 is rotated counterclockwise. An electrostatic latent image is formed on the photosensitive drum 202 by a laser scanner 201. Developing devices 221, 222, 223, 224 corresponding to black, yellow, magenta, cyan colors, respectively, are disposed around the rotation shaft 200. At the time of forming a toner image on the photosensitive drum 202, in the case a color image is formed, a developing operation is executed according to a rotating operation of a rotary color developing device 203 by rotation of a stepping motor (not shown) such that a predetermined developing device of the developing devices 221 to 224 is selectively brought into a developing position adjacent to (or in contact with) the photosensitive drum 202 around the rotation shaft 200 according to the separated color to be developed. From the developing devices 221 to 224, a toner is supplied by an amount corresponding to the charge on the photosensitive drum 202 so as to develop the electrostatic latent image on the photosensitive drum 202.

In this embodiment, the developing devices 221 to 224 are easily detachably mountable to the rotary color developing device 203. In the rotary color developing device 203, installation positions corresponding to the black, yellow, magenta, cyan colors, respectively, are designated in the clockwise direction. The developing devices 221 to 224 of respective colors are mounted at the designated color positions. At the time of developing a black monochrome image, only the black developing device 221 is used such that the rotary developing device 203 is rotated so as to bring a sleeve (not shown) of the black developing device 221 into a position opposite to the photosensitive drum 202 for toner supply. At the time of developing a full color image, all of the developing devices 221 to 224 are used such that the rotary color developing device 203 is rotated so as to bring the sleeve of each developing device into a visualizing position 226 opposite to the photosensitive drum 202 in the order of black, yellow, magenta and cyan. A toner image formed on the photosensitive drum 202 is transferred onto an intermediate transfer member 205 rotating in the clockwise direction according to rotation in the counterclockwise direction of the photosensitive drum 202. The transfer onto the intermediate transfer member 205 is completed in one revolution of the intermediate transfer member 205 in the case of the black monochrome image, and in four revolutions of the intermediate transfer member 205 in the case of the full color image. In the case of forming an image of a specific sheet size, for example, an A4 size or less, two images of these sizes can be formed on the intermediate transfer member 205.

On one hand, a sheet (recording paper) picked up by a pickup roller 211 or 212 from an upper stage cassette 208 or a lower stage cassette 209 and fed by a feed roller 213 or 214 is transported to a registration roller 219 by a transport roller 215. At the timing of finishing the transfer onto the intermediate transfer member 205, the sheet is transported between the intermediate transfer member 205 and the transfer belt 206. Thereafter, the sheet is transported by the transfer belt 206 as well as pressed on the intermediate transfer member 205 so that the toner image on the intermediate transfer member 205 is transferred onto the sheet. The toner image transferred on the sheet is heated and pressured by a fixing roller 207a and a pressure roller 207b so as to be fixed on the sheet. The sheet with the image fixed is delivered to a face up delivery port 217.

The residual toner remaining on the intermediate transfer member 205 without being transferred on the sheet is cleaned in the post process control in the latter half of the image formation sequence. In the post process control, the residual toner on the intermediate transfer member 205 after finishing the transfer on the sheet is charged in the polarity opposite to the original toner polarity by a cleaning roller 230 in FIG. 1 as the waste toner, so that the residual toner in the opposite polarity is transferred again on the photosensitive drum 202. In the photosensitive drum unit, the opposite polarity residual toner is scrapped off from the drum surface by a blade (not shown) so as to be transported to a waste toner box 231 provided integrally in the photosensitive drum unit. Accordingly, the residual toner on the intermediate transfer member 205 is cleaned completely so as to finish the post process control.

In FIG. 1, in the printer portion 2, a manually-inserted-sheet trailing edge detecting sensor S1, a manually-inserted-sheet presence or absence sensor S2, an intermediate plate position sensor S3, an ante-registration sensor S4, a separation jamming sensor S5, an inverter sensor S6, a duplex sensor S7, a re-feed sensor S8, an upper stage second sheet absence sensor S9, an upper stage sheet absence sensor S10, a lower stage second sheet absence sensor S11, a lower stage sheet absence sensor S12, a manually-inserted-sheet feed roller 216, a charger 290, fixing delivery rollers 291, inverter rollers 292, and duplex rollers 293 are provided.

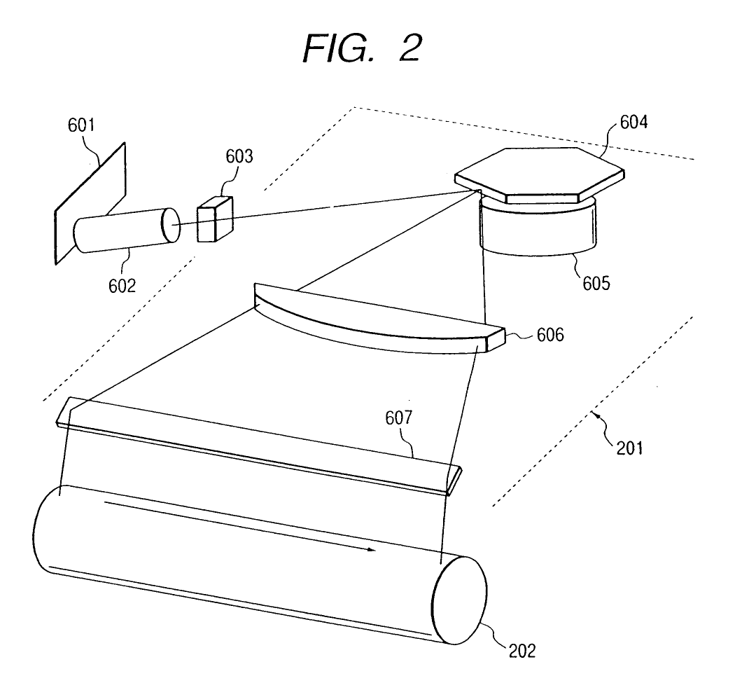

FIG. 2 is a diagram showing the schematic configuration of a laser scanner 201. A laser beam corresponding to an image data signal outputted from a laser driver circuit substrate 601 and transformed to a parallel light beam by a collimator lens 602 and a cylindrical lens 603 enters into a polygon mirror 604 rotating at a constant speed by a scanner motor 605. The laser beam reflected by the polygon mirror 604 is irradiated to the photosensitive drum 202 via an objective lens 606 disposed in front of the polygon mirror 604 and a reflection mirror 607 for scanning in the main scanning direction.

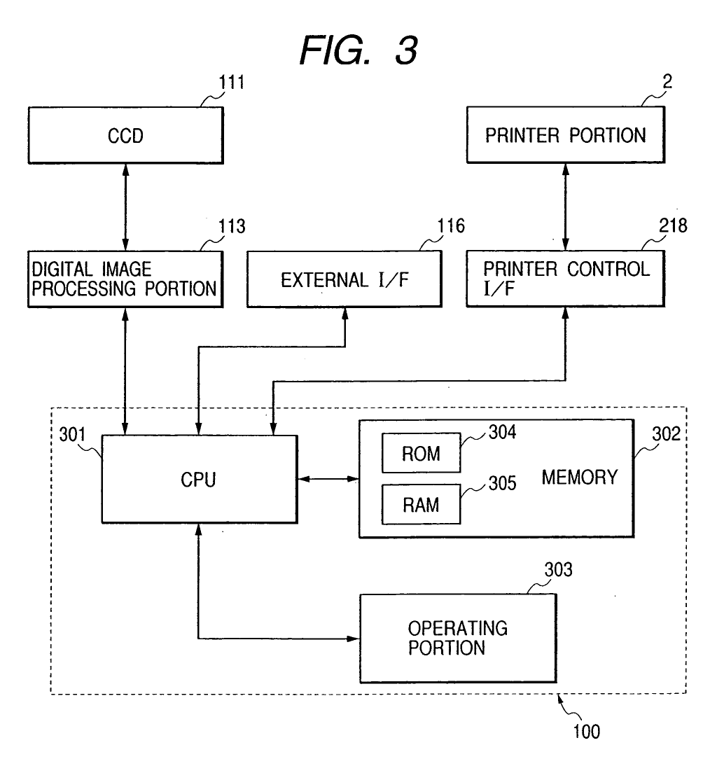

FIG. 3 is a block diagram showing the essential part configuration of the control portion 100. The control portion 100 comprises a digital image processing portion 113, a CPU 301 having an I/F for exchanging information for control against a printer control I/F 218 and an external I/F 116 and an operating portion 303, and a memory 302. The memory 302 comprises a RAM 305 for providing the work area to the CPU 301, and a ROM 304 storing the control program for the CPU 301. The ROM 304 stores a control program for executing the operation modes later described, such as the automatic color selecting (ACS) mode for automatically changing over the color image formation and the black and white image formation, the color image forming mode (it is also referred to as the color mode), and the black and white image forming mode, and a control program for controlling the entire image forming apparatus 50. Moreover, the operating portion 303 comprises a liquid crystal with a touch panel for notifying the process execution content input, and the information, the warning, or the like concerning the process by the operator.

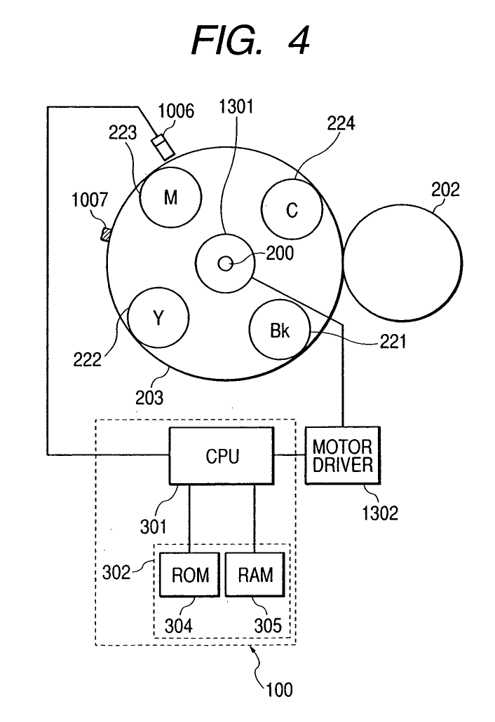

FIG. 4 is a block diagram showing the configuration of a control circuit of the rotary color developing device 203. A developing operation is executed according to a rotating operation of the rotary color developing device 203 by the rotation of the stepping motor 1301 so as to bring selectively the developing devices 221 to 224 corresponding to the separated color to be developed into a developing position in contact with (or adjacent to) the photosensitive drum 202 about the rotation shaft 200. The control circuit of the rotary color developing device 203 comprises a stepping motor 1301, a motor driver 1302, a CPU 301 for a main body controlling portion 100, a ROM 304 and a RAM 305 as the breakdown of a memory 302, and an optical sensor 1006. The CPU 301 of the main body control portion 100 outputs a pulse to the motor driver 1302 for controlling the stepping motor 1301 at the time of rotating the rotary color developing device 203. Moreover, the program stored in the ROM 304 of the main body control portion 100 determines the rotating operation state, the home position (hereinafter referred to as the “HP”), and the stopping position according to the relationship between the pulse output and the detection of the home position flag 1007 by the optical sensor 1006.

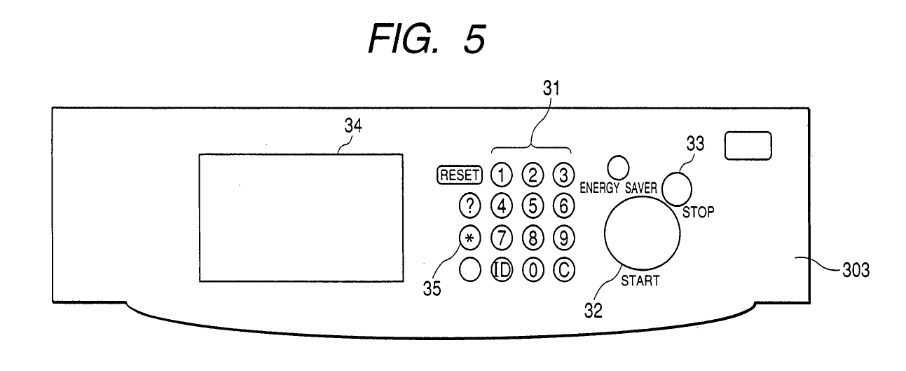

FIG. 5 is a diagram showing the configuration of the operating portion 303. The operating portion 303 comprises ten keys 31, a start key 32, a stop key 33, an LCD 34, and a user mode key 35. Here, the ten keys 31 are keys to be used for inputting the number of copies, the image moving amount at the time of copying, or the like by the user. The start key 32 is a key to be pressed down by the user at the time of starting a copying job. The stop key 33 is a key to be pressed down by the user at the time of stopping a started job by halfway. The LCD 34 is a display portion for displaying the operation state of the image forming apparatus 50. Further, the LCD 34 is provided with a panel switch such that the copying job mode can be set by the user via the panel switch.

The user mode key 35 is a key to be pressed down by the user at the time of displaying the user mode screen on the LCD 34. In the user mode screen, the standard operation of the copying machine can be set by the user, for example, the specifications for every function of the image forming apparatus 50, such as setting of the mode to be selected as the standard mode (default) in the case any of the automatic color selecting (ACS) mode described later of determining whether the image to be formed is a color image or a black and white image so as to change over the color image formation and the black and white image formation, the color image forming mode (it is also referred to as the color mode), and the black and white image forming mode (it is also referred to as the black and white mode) is not designated expressly by the user, setting of whether or not the longitudinal size and the lateral size are inputted for the paper size in the case the paper size at the time of the black and white image formation is a non-fixed size paper, setting of whether the longitudinal and lateral sizes of the paper are inputted initially or the longitudinal and lateral sizes are inputted at the time the color original is detected in the case the paper size at the time of the automatic color selecting mode is a non-fixed size paper, or the like can be selected.

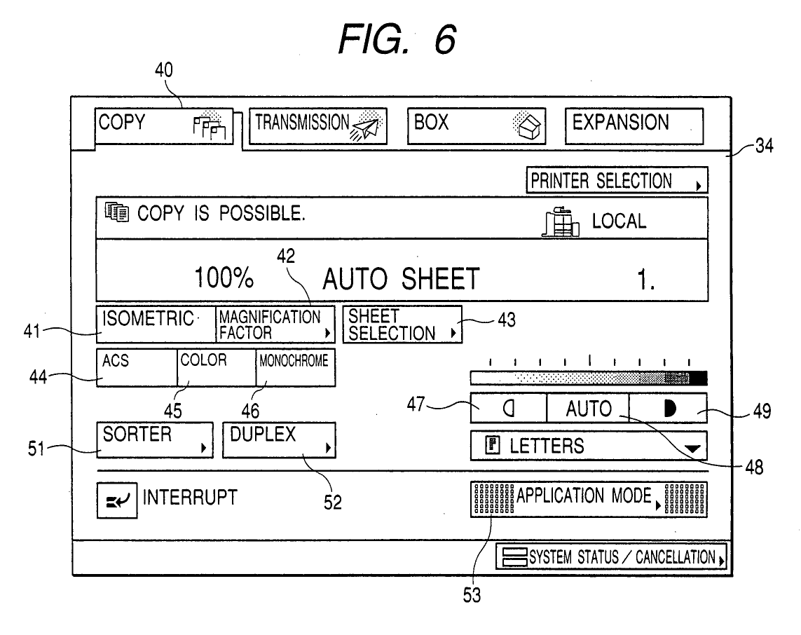

FIG. 6 is a diagram showing the display screen in the standard state of the LCD 34. In the screen 40, the numerals 41, 42 designate buttons for setting the magnification at the time of image formation. The numeral 43 designates a paper selecting button for selecting the paper size such as the various kinds of the standard sizes, and the non-fixed size papers. The numerals 44, 45, 46 designate buttons for executing the automatic color selecting (ACS) mode, the color image forming mode, and the black and white image forming mode, respectively. One of the three buttons is exclusively selected without being selected simultaneously. The numerals 47, 48, 49 designate buttons for adjusting the printing density of the image. The numeral 51 designates a button for designating the process such as stapling to be executed for the recording paper stack in the delivery paper processing device (not shown). The numeral 52 designates a button for selecting how the image is to be arranged among the types of a copying from one side to one side, a copying from one sides to two sides, a copying from two sides to one sides, and a copying from two sides to two sides. The numeral 53 designates a button for designating various kinds of application modes.

FIG. 7 is a block diagram showing the detailed configuration of the digital image processing portion 113. An original on the original glass stand 101 to be explained in detail reflects a light from the light sources 103, 104 so that the reflected light is guided to the CCD 111 so as to be transformed into an electric signal (in the case the CCD 111 is a color sensor, it may be one with the RGB color filters mounted on the one line CCD in the order of R, G, and B by inline, or it may be a three line CCD with the R filter, the G filter and the B filter arranged for each CCD, or it may be one having a filter in on-chip, or one having a filter independently from the CCD). Then, the electric signal (analog image signal) is inputted to the digital image processing portion 113, sample-held (S/H) by a clamp & Amp & S/H & A/D portion 502, with the dark level of the analog image signal clamped to the reference potential, it is amplified to a predetermined amount (the above-mentioned processing order is not limited to the order of description), and A/D transformed into, for example, a digital signal of 8 bit each for RGB. Then, the RGB signals are processed for the shading correction and the black correction in a shading portion 503. Then, in the case the CCD 111 is a three line CCD, since the reading position in the piecing process differs between the lines, the delay amount is adjusted for each line according to the reading rate in a piecing & MTF correction & original detecting portion 504 for correcting the signal timings so as to have the same reading position for the three lines. Since the reading MTF differs depending on the reading rate and the magnification ratio in the MTF correction, the change is corrected. In the original detection, the original size is recognized by scanning the original on the original glass stand 101. The digital signals with the reading position timing corrected correct the spectral characteristics of the CCD 111 and the spectral characteristics of the light sources 103, 104 and the troffers 105, 106 by an input masking portion 505. The output from the input masking portion 505 is inputted to a selector 506 switchable to an external I/F signal. The signal outputted from the selector 506 is inputted to a color space compression & background removal & LOG transforming portion 507 and a background removing portion 514. After having the background eliminated, the signal inputted to the background removing portion 514 is inputted to a black letter discriminating portion 515 for detecting black letters in the original for producing a black letter signal from the original. In addition, in the color space compression & background removal & LOG transforming portion 507 with the other output from the selector 506 inputted, the color space compression is determined according to whether the image signal is within a range to be reproduced by the printer. In the case it is within the range, it is left as it is, and in the case it is out of the range, the image signal is corrected so as to be within the range to be reproduced by the printer. Then, the background removing process is carried out, and it is transformed from the RGB signal to the YMC signal in the LOG transforming portion. For correcting the timing of the signal produced in the black letter discriminating portion 515, the output signal from the color space compression & background removal & LOG transforming portion 507 has the timing adjusted in the delaying portion 508. The two kinds of the signals have a moire elimination process in a moire removing portion 509, and are zoom-processed in the main scanning direction in a zoom processing portion 510. In a UCR & masking & black letter reflecting portion 511, for the signal processed in the zoom processing portion 510, a YMCK signal is produced from the YMC signal by the UCR process so as to be corrected into a signal according to the output of the printer in the masking processing portion as well as a discriminating signal produced in the black letter discriminating portion 515 is fed back to the YMCK signal. The signal processed in the UCR & masking & black letter reflecting portion 511 has the density adjustment in a γ correcting portion 512, then a smoothing or edge process in a filtering portion 513. The processed signal is transmitted to the printer portion 2.

FIG. 8 is a diagram showing the process after receipt in the printer portion 2 of the signal processed in the digital image processing portion. The received eight-bit multi-value signal is transformed into a binary signal in a binary transforming portion 401. As to the transforming method, any of a dither method, an error diffusion method, an improved error diffusion, or the like can be used. The transformed binary signal is transmitted to the external I/F 116 and the delay portion 402. In the external. I/F 116, as needed, the received signal is transmitted to an external output device such as a facsimile (not shown). For correcting the received signal and the laser light emission timing of the laser scanner portion 201, the delay portion 402 adjusts the timing for transmission to the laser scanner portion 201.

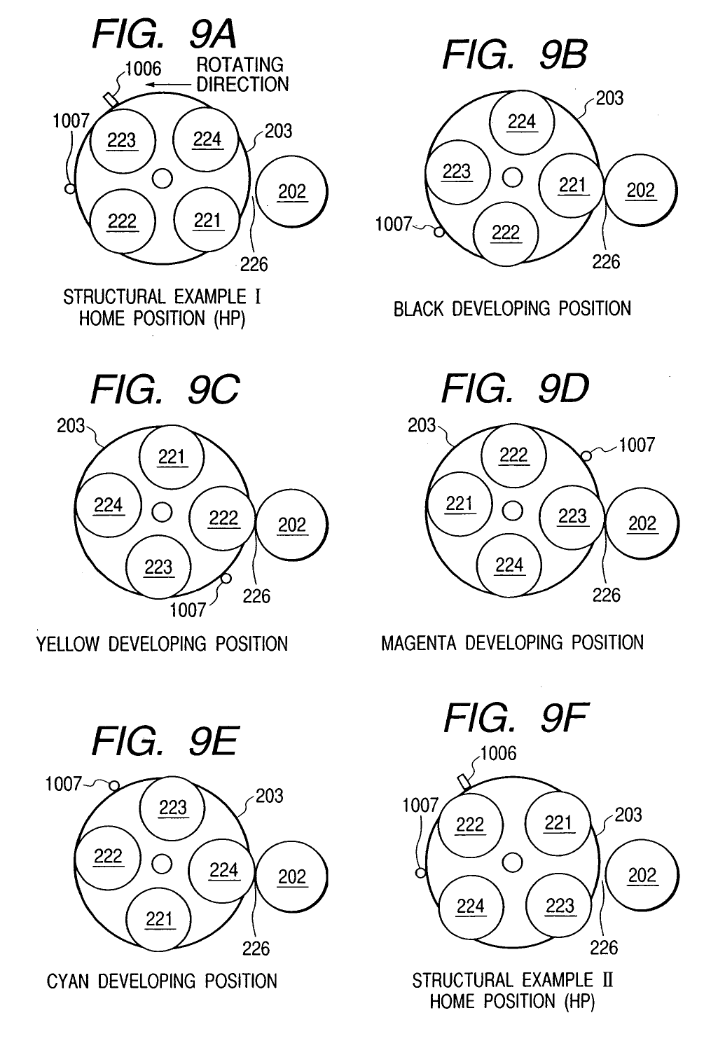

FIGS. 9A, 9B, 9C, 9D, 9E and 9F are diagrams showing respective stopping positions of the rotary color developing devices 203. The rotary color developing device 203 is maintained at a predetermined rotation position, that is, at the HP position 701 except at the time of image formation. The HP position 701 is a position with the visualizing portion 226 disposed between the black developing device 221 and the cyan developing device 224. In the case the rotary color developing device 203 is rotated to the HP position, the CPU 301 uniformly rotates the stepping motor 1301 via the motor driver 1302 such that the rotary color developing device 203 is moved to the HP position (FIG. 9A) by rotating the motor for predetermined pulses from the time the optical sensor 1006 mounted in the vicinity of the rotary color developing device 203 detects the home position flag 1007.

The home position detecting operation for moving the rotary color developing device 203 to the HP position (FIG. 9A) is executed each time when the power source of the image forming apparatus 50 is switched on, the apparatus is recovered from the low power consumption mode to the ordinary mode, the front door cover (not shown) of the image forming apparatus 50 is closed by the jamming process, or the like, and the black developing process is finished in the image formation.

At the time of the home position detecting operation, even in the case pulses corresponding to one revolution are transmitted to the stepping motor 200 for rotating the rotary color developing device 203, if the optical sensor 1006 does not detect the home position flag 1007, the rotating operation of the rotary color developing device 203 is determined to be abnormal by the program stored in the ROM 304 of the main body control portion 100. Further, the detection result output from the optical sensor 1006 is transmitted to the CPU 301 of the main body control portion 100 as shown in FIG. 4. Moreover, the pulse transmission to the stepping motor 200 for rotating the rotary color developing device 203 is executed from the CPU 301 of the main body controlling portion 100 to the motor driver 1302 for controlling the stepping motor 200.

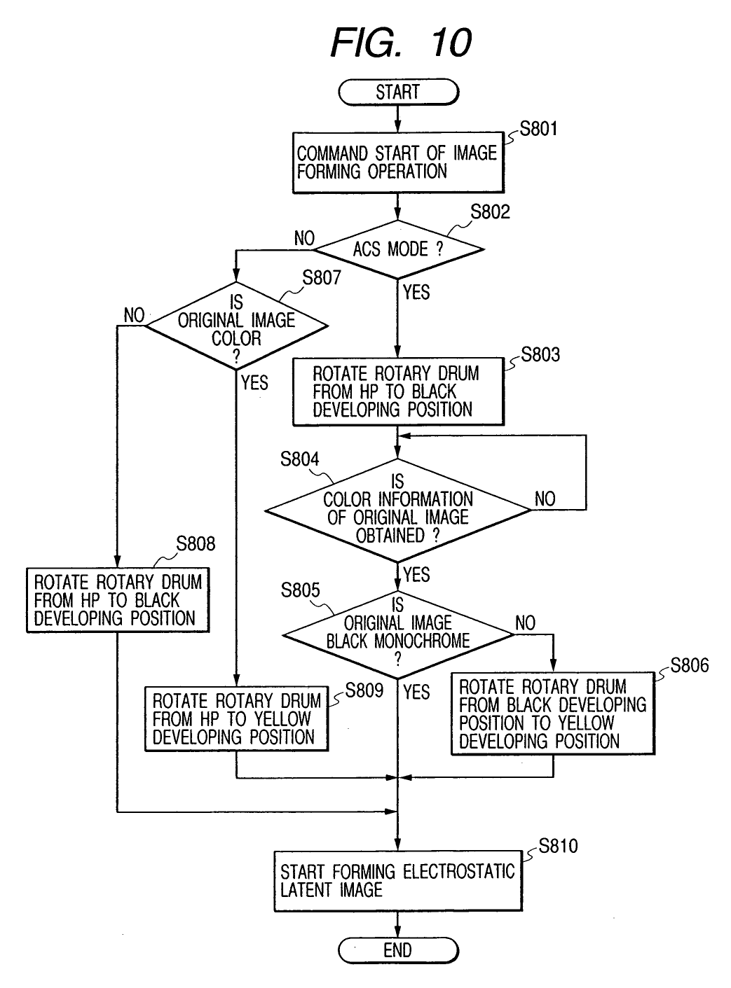

Finally, details of the control of the rotary color developing device 203, which are characteristic of this embodiment, will be explained with reference to FIGS. 9A to 9F, and FIG. 10. In the image forming apparatus 50 shown in this embodiment, the color mode, the black and white mode, and the auto color select (ACS) mode for changing over the color image formation and the black and white image formation by determining whether the original image is a color image or a black and white image as the image forming mode, are prepared. The ACS (Auto Color Select) mode is a mode of automatically recognizing whether the original image is monochrome or colored at the time of reading the original by the reader portion 1, and executing the image forming process in the black and white mode (it is also referred to as the monochrome mode) in the case the original image is monochrome, and in the mode equivalent to the color mode in the case the original image is of colors. Here, the process in the ACS mode will be explained. In the case the operator presses down the copy starting button 32 in the operating portion 303, the reading operation for the original placed on the original glass stand 101 is started in the reader portion 1 as well as the image forming operation starting command (S801) is transmitted to the printer portion 2, so that the drive of the photosensitive drum 202 and the peripheral units (such as the intermediate transfer member 205) is started in the printer portion 2 with the command received. At the time, it is determined whether or not the image forming mode is the ACS mode (S802). In the case it is not the ACS mode, the rotary color developing device 203 is on stand by at the HP position (FIG. 9A). Thereafter, when the image forming preparations are made in the printer portion 2, the image information is transmitted from the reader portion 1. It is determined whether the received image information is monochrome or colored (S807). In the case the original image is black monochrome, the rotary color developing device 203 is rotated counterclockwise to the black developing position (FIG. 9B) (S808) so as to change over the developing device. In order to visualize the electrostatic latent image by adhering a toner, the rotary color developing device 203 should be rotated to the black developing position (FIG. 9B) before the electrostatic latent image formed at the laser irradiating position 225 reaches at the visualizing position 226 in which the photosensitive drum 202 and one of the sleeves of the developing devices 221 to 224 are opposite to each other. That is, the electrostatic latent image formation starting time should be after the time calculated by the following formula:

(Time T1 for completing the rotation of the rotary color developing device 203 from the HP position (FIG. 9A) to the black developing position (FIG. 9B))−(Time T2 needed for moving the electrostatic latent image from the laser irradiating position 225 to the visualizing position 226).

In contrast, in the case the original image is colored, the rotary color developing device 203 is rotated counterclockwise from the HP position (FIG. 9A) to the yellow developing position (FIG. 9C) (S809) for changing over the developing device so as to be rotated successively to the magenta developing position (FIG. 9D), the cyan developing position (FIG. 9E), and the black developing position (FIG. 9B). In this case, the electrostatic latent image formation starting time should be after the time calculated by the following formula:

(Time T3 for completing the rotation of the rotary color developing device 203 from the HP position (FIG. 9A) to the yellow developing position (FIG. 9C))−(Time T2 needed for moving the electrostatic latent image from the laser irradiating position 225 to the visualizing position 226).

In the above-mentioned example, the developing device is changed over by rotating the rotary color developing device 203 from the HP position (FIG. 9A) to the black developing position (FIG. 9B) (S808) or to the yellow developing position (FIG. 9C) (S809) at the time the original image color is determined to be monochrome or colored (S807). At the time, since the above-mentioned times satisfy the below-mentioned relationship:

T1>T2, T3>T2,

The rotation time of the rotary color developing device 203 shown by T1 and T3 is the obstacle in shortening the FCOT.

In order to cope with the problem, in the case of the ACS mode (S802), when the operator presses down the copy starting button 32 in the operating portion 303, the rotary color developing device 203 is rotated from the HP position (FIG. 9A) to the black developing position (FIG. 9B) (S803) so as to be on standby thereat. Then, in the case the original image is black monochrome (S805), the electrostatic latent image formation is started immediately (S810). In contrast, in the case the original image is colored, the rotary color developing device 203 is rotated counterclockwise from the black developing position (FIG. 9B) to the yellow developing position (FIG. 9C) (S806), so that the electrostatic latent image formation is started at the timing corresponding to the rotation completing time (S810).

Thereby, the rotation time of the rotary color developing device 203 is shortened to zero in the case the original image is black monochrome, and to the rotation time from the black developing position (FIG. 9B) to the yellow developing position (FIG. 9C), so that the electrostatic latent image formation starting timing can be made earlier. As a result, the real average value of the FCOT can be made smaller.

### OTHER EMBODIMENTS

Although the mounting order of the developing devices is set in the order of black, yellow, magenta, cyan in the clockwise direction as shown in the structural example I (FIG. 9A) in this embodiment so as to have the developing order of yellow, magenta, cyan, and black in the case the original image is colored, the mounting order of the developing devices and the developing order are not particularly limited thereto. For example, as shown in the structural example II (FIG. 9F), the mounting order can be magenta, cyan, yellow, black in the clockwise direction, with the HP position as the visualizing position 226 disposed between the magenta developing device 223 and the black developing device 221 (FIG. 9F). If the developing order in the case the original image is colored is magenta, cyan, yellow, black, when the copy starting button is pressed down in the ACS mode, first, the black developing device 221 is rotated from the HP position (FIG. 9F) to the visualizing position 226 in the counterclockwise direction so as to be on standby thereat. In the case the original image is black monochrome, the electrostatic latent image formation is started immediately. In contrast, in the case the original image is colored, the rotary color developing device 203 is rotated from the black developing position to the magenta developing position, so that the electrostatic latent image formation is started at the timing corresponding to the rotation completing time. This is effective for shortening the FCOT particularly in the case the original image is frequently black monochrome. In addition thereto, in the case the original image is frequently colored, first, it is rotated from the HP position to the magenta developing position so as to be on standby thereat. Then, in the case the original image is colored, the electrostatic latent image formation is started immediately. In contrast, in the case the original image is black monochrome, the rotary color developing device 203 is rotated from the magenta developing position to the black developing position so as to start the electrostatic latent image formation at the timing corresponding to the rotation completing timing.

A configuration wherein the change-over of the standby position corresponding to the frequency may be set by the operator or set automatically can be used as well. The change-over method of the standby position corresponding to the frequency will be explained. In the case the operator presses down the user mode key 35, the user mode screen is displayed on the LCD 34 (not shown). In the above-mentioned user mode screen, either of the color image forming mode, the black and white image forming mode, and the ACS mode can be selected. For example, in the case the original image is frequently colored, the operator designates the color image forming mode as the standby position at the time of the ACS mode in the above-mentioned user mode screen. That is, in the case the copy command is provided under the setting, the rotary color developing device 203 is rotated from the HP position to the magenta developing position so as to be on standby thereat. In the case the original image is colored, the electrostatic latent image formation is started immediately.

In addition, although the case of the ACS is explained in this embodiment as the image forming mode, the image forming mode is not particularly limited to the ACS, and it may be the total mode including the monochrome mode and the color mode. This can be adopted in an apparatus with the configuration having the copy mode information selected in the reader portion 1 is not notified in the printer portion 2 until the image information is received.

Further, although the intermediate transfer member 205 is shown as the drum in this embodiment, the intermediate transfer member is not particularly limited to the drum, and it may have a belt-like shape. Furthermore, although the developing devices of the four colors including black, yellow, magenta, cyan are provided in the rotary color developing device in this embodiment, the developing devices provided in the rotary color developing device are not particularly limited thereto. For example, the developing devices of the three colors including yellow, magenta, cyan may be provided in the rotary color developing device, and the black developing device may be provided independently in the vicinity of the latent image bearing member. As the operation in this case, in the case the printer portion 2 receives the developing device starting command, the rotary color developing device is rotated to the vicinity of the yellow developing position so as to be on standby thereat. After making determination on whether the original image is monochrome or colored, in the case it is black monochrome, the electrostatic latent image formation is started immediately using the black developing device provided independently in the vicinity of the latent image bearing member. In contrast, in the case it is colored, the yellow developing position being on standby in the vicinity of the yellow developing position is rotated to the developing position so as to start the electrostatic latent image formation.

Moreover, for example, the developing devices of the six colors including black, yellow, thick magenta, thin magenta, thick cyan, thin cyan may be provided. As the operation in this case, by providing a high speed color mode for image formation using the four colors including black, yellow, thick magenta, thick cyan as the first mode, and a image quality priority color mode for image formation using the six colors including black, yellow, thick magenta, thin magenta, thick cyan, thin cyan as the second mode, according to determination by the automatic discriminating ACS mode for automatically discriminating the kind of the inputted image on whether it is a letter image or a graphic image, it can be set in the user mode screen so as to select the image quality priority color mode in the case of requiring a higher image quality. In the case the printer portion 2 receives the developing device starting command, the rotary color developing device is rotated to the vicinity of the thin magenta developing position to be used initially in the image quality priority color mode so as to be on standby thereat. After making determination on whether the original image is a letter image or a graphic image, in the case it is a letter image, it is rotated from the thin magenta developing position to the thick magenta developing position so as to start the electrostatic latent image formation at the timing corresponding to the rotation completing time. In the case it is a graphic image, the electrostatic latent image formation is started immediately using the thin magenta developing device.

Further, for example, for the black color, by providing a mono-component black developing device for letters, and providing a two-component black developing device for graphics, they can be used optionally according to the mode, that is, the letter priority mode and the image quality priority mode.

Furthermore, the original image is not limited to the paper original read by the CCD 111 of the reader portion 1, but it may be an image from a personal computer connected with the external I/F in FIG. 3. That is, although the process of the image forming operation at the time of the copying operation has been explained in this embodiment, the image forming operation is not particularly limited to the copy operation, and it may be a process at the time of the printer operation or the facsimile operation.

What is claimed is:

1. An image forming apparatus comprising:
a latent image bearing member;
a developing portion having a plurality of developing devices and provided opposite to said latent image bearing member;
an inputting portion for inputting an image signal;
an auto-discriminating portion for automatically discriminating the kind of an inputted image;
a first mode for executing a monochrome image formation;
a second mode for executing a color image formation;
an auto-selecting mode for changing over said first mode and said second mode according to a discrimination of said auto-discriminating portion; and
a control portion for starting to move a predetermined developing device to a predetermined position before said auto-discriminating portion makes the discrimination when said auto-selecting mode is selected.

2. An image forming apparatus according to claim 1, wherein said predetermined developing device is a developing device to be used in said first mode.

3. An image forming apparatus according to claim 1, wherein said predetermined developing device is a developing device to be used initially in said second mode.

4. An image forming apparatus according to claim 1, wherein said control portion further moves a developing device different from said predetermined developing device to a developing position according to the discrimination.

5. An image forming apparatus according to claim 1, wherein said plurality of developing devices are disposed around a rotation shaft in said developing portion, and said developing portion is rotated about the rotation shaft to bring a developing device of said plurality of developing devices into a developing position opposite to said latent image bearing member to perform a development.

6. An image forming apparatus according to claim 1, wherein when a developing device to be used initially in a mode changed over according to the discrimination of said auto-discriminating portion is different from said predetermined developing device, said control portion moves said developing device to be used initially into a developing position.

7. An image forming apparatus according to claim 1, wherein said auto-discriminating portion discriminates whether the inputted image is monochrome or colored.

8. An image forming apparatus according to claim 1, wherein said control portion selects said predetermined developing device, which starts to move before said auto-discriminating portion makes the discrimination, according to a setting set by an operator.

9. An image forming apparatus according to claim 1, wherein said control portion selects said predetermined developing device, which starts to move before said auto-discriminating portion makes the discrimination, according to a frequency in use of said first mode and a frequency in use of said second mode of said image forming apparatus.

10. An image forming apparatus according to claim 1, wherein said developing portion is provided with a black developing device.

11. An image forming apparatus comprising:
a latent image bearing member;
a developing portion having a plurality of developing devices and provided opposite to said latent image bearing member;
an inputting portion for inputting an image signal;
an auto-discriminating portion for automatically discriminating the kind of an inputted image;
a first mode for executing an image formation using a first developing device;
a second mode for executing an image formation without using said first developing device;
an auto-selecting mode for changing over said first mode and said second mode according to a discrimination of said auto-discriminating portion; and
a control portion for starting to move a predetermined developing device to a predetermined position before said auto-discriminating portion makes the discrimination when said auto-selecting mode is selected.

12. An image forming apparatus according to claim 11, wherein said predetermined developing device is a developing device to be used in said first mode.

13. An image forming apparatus according to claim 11, wherein said predetermined developing device is a developing device to be used initially in said second mode.

14. An image forming apparatus according to claim 11, wherein at least a developer contained in said first developing device of said plurality of developing devices is a mono-component developer.

15. An image forming apparatus according to claim 11, wherein said control portion selects said predetermined developing device, which starts to move before said auto-discriminating portion makes the discrimination, according to a setting set by an operator.

16. An image forming apparatus according to claim 11, wherein said control portion selects said predetermined developing device, which starts to move before said auto-discriminating portion makes the discrimination, according to a frequency in use of said first mode and a frequency in use of said second mode of said image forming apparatus.

17. An image forming apparatus according to claim 11, wherein said developing portion has at least one or more sets of developing devices having developers of the same color and different densities.

18. An image forming apparatus according to claim 11, wherein said developing portion has at least one or more sets of developing devices having developers of the same color and different components.
